(19) United States
(12) Patent Application Publication
(10) Pub. No.: US 2010/0095904 A1
(43) Pub. Date: Apr. 22, 2010

(54) EQUIPMENT FOR ASEPTIC HANDLING OF LABORATORY ANIMALS

(75) Inventor: Fernando Javier Palacín Urquijo, Madrid (ES)

Correspondence Address: IP Patent Docketing;K&L GATES LLP, 599 Lexington Avenue, 33rd Floor, New York, NY, 10022-6030, US

(73) Assignee: CONSEJO SUPERIOR DE INVESTIGACIONES CIENTIFICAS, Madrid (ES)

(21) Appl. No.: 12/516,951

(22) PCT Filed: Nov. 27, 2007
(86) PCT No.: PCT/ES07/70197

§ 371 Date: Jul. 31, 2009

(30) Foreign Application Priority Data
Nov. 30, 2006 (ES) P200603074

(51) Int. Cl. A01K 15/04

(52) U.S. Cl. 119/801

(57) ABSTRACT

Disclosed herein are systems and methods to move animals.

### CROSS-REFERENCES TO RELATED APPLICATIONS

This application claims the benefit under 35 U.S.C. §371 to PCT/ES2007/070197 filed Nov. 27, 2007, which claims the benefit of Patent Application P200603074 filed Nov. 30, 2006 in Spain. The entire disclosures of said applications are incorporated herein by reference thereto.

### BACKGROUND

Animal experimentation and/or care requires handling and moving many animals on a daily basis, not only for experimental reasons but also for their maintenance and production.

Within the field of animal experimentation and/or care, one challenge is to avoid contamination of the animals caused by microorganisms. In most modern facilities, to avoid the risk of contamination, animals are housed in sterile areas or white rooms, equipped with a series of barriers including air filters and “ventilated” cages connected to sterile air ducts. Often, cages, bedding, feed, drinking water, etc. are also sterilized.

For their part, animal handlers often attempt to wear sterile clothing. Most animal contamination occurs, however, during handling. When one animal is contaminated by a handler, the contamination can be transmitted to other animals located in the contaminated animal's cage.

The consequences of animal contamination can be serious, as it can affect experimental results and require the need to repeat the experimental work without animal contamination.

### BRIEF DESCRIPTION OF THE DRAWINGS

For the purpose of complementing this description and helping to better understand the example embodiments disclosed herein, a set of drawings in accordance with some particular example embodiments has been included as an integral part of this specification, wherein the following have been represented in an illustrative and non-limiting manner:

FIG. 1 shows, according to a perspective schematic representation, an exemplary holding device;

FIG. 2 shows, also according to a perspective view, a detail of the coupling of a disposable cover to the device depicted in FIG. 1;

FIG. 3 shows one mechanism to remove the cover after use;

FIG. 4 shows a detail of the capture or deposition of a cover, with a complementary cover sterilizer;

FIG. 5 shows the exemplary holding device of FIG. 1 in use to hold a mouse during handling;

FIG. 6 shows the exemplary holding device of FIG. 1 in use to release a mouse during handling;

FIG. 7 shows a source of vacuum that can be used to provide suction for a plurality of holding devices.

### DETAILED DESCRIPTION OF EXAMPLE EMBODIMENTS

Some of the example embodiments disclosed herein allow for aseptic handling of animals reducing the risk of animal contamination by handlers. Embodiments disclosed herein allow for such aseptic handling by providing a holding device through which a suction force can secure the animal to the holding device. The animal can be released from the holding device by interrupting the suction force.

To achieve the aseptic handling, a cover can be removably coupled to an opening on the holding device. The cover can be coupled and decoupled from the holding device without direct manual contact by the animal handler. In certain example embodiments, the cover can be coupled to the holding device through the use of suction. Alternatively, a combination of participation of ferrous materials and magnets may be used to couple the cover to the holding device. It will be appreciated that other kinds of coupling may also be provided. In one example embodiment, covers can be decoupled by interrupting the force used to couple it. Other example embodiments can include a cover decoupling device that, in a further example embodiment, can be controlled by a trigger.

In some of the example embodiments, the covers described herein can be single-use or reusable. In the case of single-use covers, a cover supply device of adequate capacity can be provided. In the case of reusable covers, covers should be sterilized between each use. One appropriate sterilization technique includes the use of an electric Bunsen-type sterilizer, although it will be appreciated that other approaches to sterilization may also be employed, as appropriate to the material being sterilized.

In some of the example embodiments, holding devices described herein can be coupled to a vacuum source. Each holding device can have a port easily accessible, e.g., in one example embodiment, by the thumb of the animal handler. It will be appreciated that other sealing mechanisms can be used.

When the port is sealed by the animal handler the resulting suction can secure an animal to the holding device. The animal can then be released by unsealing the port—in one example embodiment by separating the finger from the port. As air is allowed to flow through the port, negative pressure is lost and becomes insufficient to secure the animal to the holding device.

Certain example embodiments disclosed herein can incorporate one or more filters for retaining particles and preventing their entry into the vacuum source.

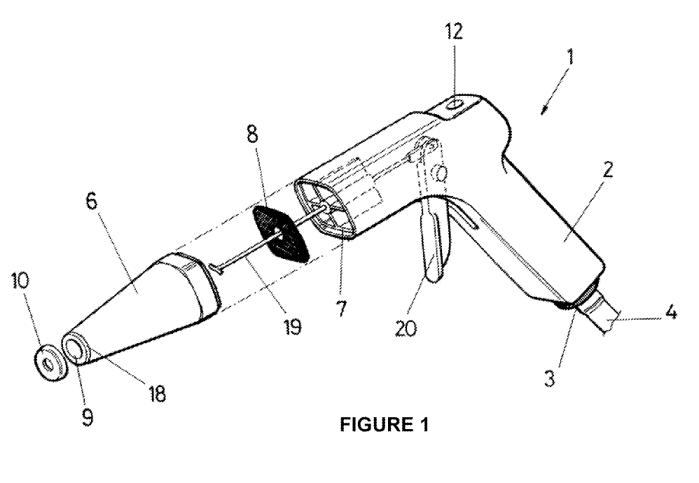

Turning to the example embodiments depicted in the figures, FIG. 1 depicts one exemplary holding device. This depicted holding device (1) includes a handle (2) which ends in a joint nut (3). The joint nut may provide a connection to a pipe (4) through which said holding device (1) is coupled to a vacuum source. The depicted example device (1) may include a head (6) with an opening (9) at its distal end. The head (6) can be frontally coupled to and decoupled from the mouth (7) of the device (1). In this depicted example embodiment, a filter (8) can be mounted between the head (6) and the mouth (7). The head (6) and the handle may be substantially hollow. Opening (9) of the head (6) may provide an area to which a cover (10) can be removably coupled. When the source of vacuum is in operation and the port (12) is sealed, suction is produced through the cover (10), thereby allowing the device to hold an animal (11) as shown in FIG. 5.

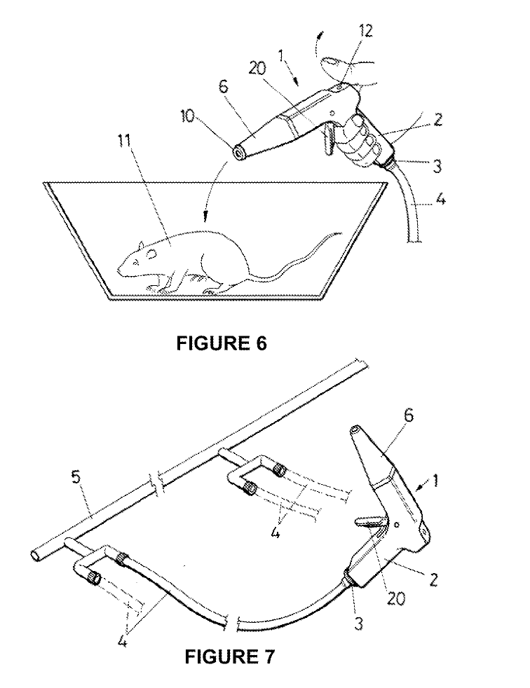

It is appreciated that the animal may be released by removing or deactivating the vacuum source. Alternatively, in some example embodiments, vacuum source (5) does not need to stop working in order to release the animal due to the presence of the port (12). In the depicted embodiment, the port (12) is disposed in opposition to the thumb of the hand of the handler, in a working position in such a manner that when the port (12) is uncovered air can travel through it reducing suction and thereby releasing the animal, as shown in FIG. 6. It will be appreciated that, instead of the thumb, a valve or other device for controlling air travel may also be employed.

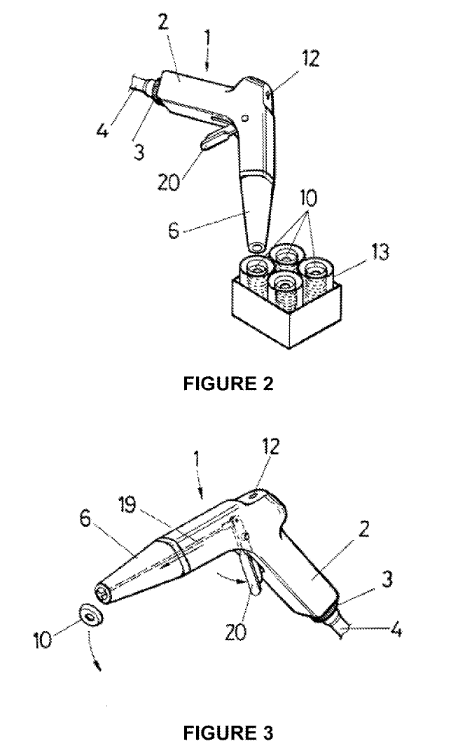

As mentioned earlier, the cover (10) may be of a single-use disposable nature. When single-use covers are used, a storage deposit containing sterile covers can be provided. FIG. 2 depicts one exemplary embodiment of a cover storage deposit. In this depicted embodiment, a plurality of covers is disposed in piles and can be individually extracted with the holding device (1).

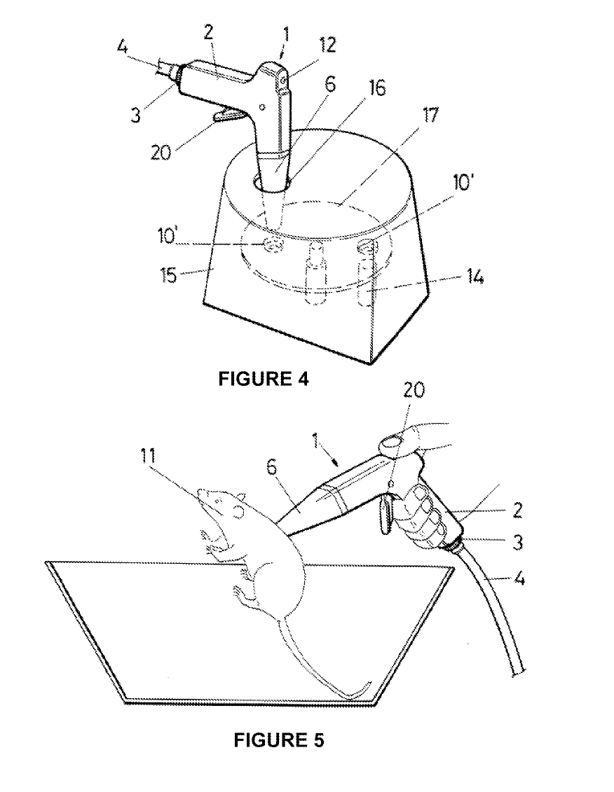

FIG. 4 depicts an electric Bunsen-type sterilizer (14) that can be used when reusable covers (10′) are used. In the depicted example embodiment, the sterilizer and reusable covers (10′) may be housed within a casing (15) equipped with an access port (16) for the holding device (1), in such a manner that through said port (16) the head (6) of the holding device (1) partially penetrates the casing (15), accessing a reusable cover (10′). Following use, the accessed cover (10′) can be deposited onto a rotating plate (17) which can place the used cover (10′) in or on a sterilizer (14), e.g., by rotating turntable 180 degrees. Rotation of the plate (17) can also place an already-sterilized cover (10′) in position to be accessed by the head (6) of the holding device (1).

Each cover may be directly captured by the holding device, without requiring manual contact with the covers, although it will be appreciated that other approaches may be used for coupling the covers to the holding device. As stated, the depicted covers (10-10′) can be coupled to the head (6) of the holding device (1) by the same vacuum source causing the suction effect and/or by utilizing covers with a ferrous nature that will allow the fixation thereof with the collaboration of a magnet (18). In these example embodiments, decoupling of the cover can be achieved in the first case by interrupting the suction effect and, in the second case, with the use of a decoupling device. FIG. 3 depicts one embodiment of a decoupling device (19) housed within the head (6) which may be actuated by a trigger (20). In this example embodiment, axial displacement of the decoupling device (19) pushes the cover (10-10′) away from the head (6), separating it from the opening (9). While several decoupling mechanisms have been illustrated, any other appropriate mechanism can also be used to couple and decouple the cover (10-10′), so long as the mechanism does not require direct cover handling by the animal handler.

FIG. 7 depicts a vacuum source (5) including appropriate piping and ducts (4) to provide suction for a plurality of holding devices. In this depicted example embodiment, the holding devices can be connected in parallel to a single depressor (5), for example using a distribution network that can be embedded in and/or fixed to the walls and/or ended in automatic shut-off keys, which can be used both simultaneously or selectively.

As can be seen from the foregoing, some of the example embodiments disclosed herein provide holding devices where the only elements that come into contact with experimental animals are the aforementioned disposable or reusable sterile covers. Use of these holding devices reduces the risk of animal contamination due to handling. While the example embodiments have been presented in terms of use with experimental animals, these embodiments could be used with any animals kept in captivity where contamination may be an issue, such as in pet stores, farming operations, or other animal facilities.

One example embodiment disclosed herein includes an aseptic animal handling apparatus comprising: a substantially hollow holding device having a distal end, a proximal end, and a port between the distal end and the proximal end, wherein the distal end has an opening and is configured to receive a removable sterile cover that permits communication of a suction force from the opening to an animal, the holding device configured to be coupled to a vacuum source at the proximal end so that the hollow portion of the holding device is in communication with the vacuum, and wherein when the holding device is in communication with the vacuum source and the port is sealed, the suction force at the distal end opening is created. Another example embodiment includes the sterile cover removably coupled to the distal end of the holding device. The sterile cover optionally can be coupled by suction force and/or magnetic force.

In one example embodiment the holding device further comprises a filter between the distal end opening and the port.

In another example embodiment, the holding device further comprises a rod coupled to a trigger, wherein movement of the trigger axially displaces the rod towards the distal end opening.

Example embodiments can also optionally include a casing, the casing including a port sized to accept the distal end opening of the holding device; and a cover sterilizer, within the casing.

Example embodiments disclosed herein also include aseptic animal handling systems. One example system includes a plurality of sterile covers; and a plurality of substantially hollow holding devices each having a distal end, a proximal end, and a port between the distal end and the proximal end, wherein each of the distal ends has an opening and is configured to receive a removable sterile cover that permits communication of a suction force from the opening to an animal, the holding devices configured to be coupled to a vacuum source at each of the proximal ends so that the hollow portion of the holding devices is in communication with the vacuum, and wherein when a holding device is in communication with the vacuum source and the on the holding device port is sealed, the suction force at the distal end opening is created.

Optionally, example system embodiments can also include a vacuum source. In other example embodiments, at least a subset of the holding devices further comprise a filter between the distal end opening and the port. In yet other example embodiments at least a subset of the holding devices further comprise a rod coupled to a trigger, wherein movement of the trigger axially displaces the rod towards the distal end opening.

Example embodiments disclosed herein also include methods. One example is a method of moving an animal including connecting a holding device to a vacuum source; using the holding device to apply a suction force to the animal through the holding device from the vacuum source; and maintaining contact between the holding device and the animal using the suction force while moving the animal using the holding device. Another example embodiment includes modulating the suction force by sealing and/or unsealing a port within the holding device.

In one example method embodiment, the holding device is substantially hollow and has a distal end, a proximal end, and a port between the distal end and the proximal end, wherein the distal end has an opening and is configured to receive a removable sterile cover that permits communication of a suction force from the opening to an animal, the holding device configured to be coupled to a vacuum source at the proximal end so that the hollow portion of the holding device is in communication with the vacuum, and wherein when the holding device is in communication with the vacuum source and the port is sealed, the suction force at the distal end opening is created.

Optionally, the holding device further includes: a filter between the distal end opening and the port.

In certain example embodiments, the holding device further comprises: a rod coupled to a trigger, wherein movement of the trigger axially displaces the rod towards the distal end opening.

Example method embodiments can also include sterilizing the cover after moving the animal. Optionally the sterilizing can occurs in a casing having a port sized to accept the distal end opening of the holding device.

In additional example method embodiments, the sterile cover is removably coupled to the distal end opening by the suction force. Optionally or additionally, the sterile cover or the holding device comprises a ferrous material such that the sterile cover and the holding device can be removably coupled by a magnetic force.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of the following claims are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

The use of the term “or” in the claims is used to mean “and/or” unless explicitly indicated to refer to alternatives only or the alternatives are mutually exclusive, although the disclosure supports a definition that refers to only alternatives and “and/or.”

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects those of ordinary skill in the art to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Further, it is to be understood that the example embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described in the specification and drawings.

1-9. (canceled)

10. An aseptic animal handling apparatus comprising:
a substantially hollow holding device having a distal end, a proximal end, and a port between said distal end and said proximal end,
wherein said distal end has an opening and is configured to receive a removable sterile cover that permits communication of a suction force from the opening to an animal,
said holding device configured to be coupled to a vacuum source at the proximal end so that the hollow portion of said holding device is in communication with the vacuum,
and wherein when said holding device is in communication with said vacuum source and said port is sealed, the suction force at said distal end opening is created.

11. An aseptic animal handling apparatus of claim 10, further comprising:
said sterile cover removably coupled to said distal end of said holding device.

12. An aseptic animal handling apparatus of claim 11, wherein said sterile cover is removably coupled to said distal end opening by said suction force.

13. An aseptic animal handling apparatus of claim 11, wherein said sterile cover is removably coupled to said distal end by a magnetic force.

14. An aseptic animal handling apparatus of claim 10, wherein said holding device further comprises a filter between said distal end opening and said port.

15. An aseptic animal handling apparatus of claim 10, wherein said holding device further comprises a rod coupled to a trigger, wherein movement of said trigger axially displaces said rod towards said distal end opening.

16. An aseptic animal handling apparatus of claim 10, further comprising:
a casing, the casing including a port sized to accept said distal end opening of said holding device; and
a cover sterilizer, within said casing.

17. An aseptic animal handling system comprising:
a plurality of sterile covers; and
a plurality of substantially hollow holding devices each having a distal end, a proximal end, and a port between said distal end and said proximal end,
wherein each of said distal ends has an opening and is configured to receive a removable sterile cover that permits communication of a suction force from the opening to an animal,
said holding devices configured to be coupled to a vacuum source at each of said proximal ends so that the hollow portion of said holding devices is in communication with said vacuum,
and wherein when a holding device is in communication with said vacuum source and said on said holding device port is sealed, the suction force at said distal end opening is created.

18. An aseptic animal handling system of claim 17, further comprising:
said vacuum source.

19. An aseptic animal handling system of claim 17, wherein at least a subset of said holding devices further comprise a filter between said distal end opening and said port.

20. An aseptic animal handling system of claim 17, wherein at least a subset of said holding devices further comprise a rod coupled to a trigger,
wherein movement of said trigger axially displaces said rod towards said distal end opening.

21. A method of moving an animal comprising:
connecting a holding device to a vacuum source;
using said holding device to apply a suction force to said animal through said holding device from said vacuum source; and
maintaining contact between said holding device and said animal using said suction force while moving said animal using said holding device.

22. A method of claim 21, further comprising:
modulating said suction force by sealing and/or unsealing a port within said holding device.

23. A method of claim 21, wherein said holding device is substantially hollow and has a distal end, a proximal end, and a port between said distal end and said proximal end,
wherein said distal end has an opening and is configured to receive a removable sterile cover that permits communication of a suction force from the opening to an animal,
said holding device configured to be coupled to a vacuum source at the proximal end so that the hollow portion of said holding device is in communication with the vacuum,
and wherein when said holding device is in communication with said vacuum source and said port is sealed, the suction force at said distal end opening is created.

24. A method of claim 23, wherein said holding device further comprises:
a filter between said distal end opening and said port.

25. A method of claim 23, wherein said holding device further comprises:
a rod coupled to a trigger,
wherein movement of said trigger axially displaces said rod towards said distal end opening.

26. A method of claim 23, further comprising:
sterilizing said cover after moving said animal.

27. A method of claim 26, wherein said sterilizing occurs in a casing having a port sized to accept said distal end opening of said holding device.

28. A method of claim 23, wherein said sterile cover is removably coupled to said distal end opening by said suction force.

29. A method of claim 23, wherein said sterile cover or said holding device comprises a ferrous material such that said sterile cover and said holding device can be removably coupled by a magnetic force.
